(19) United States
(12) Patent Application Publication
(10) Pub. No.: US 2025/0298297 A1
(43) Pub. Date: Sep. 25, 2025

(54) DISPLAY DEVICE AND CONTROL METHOD FOR DISPLAY DEVICE

(71) Applicant: SEIKO EPSON CORPORATION, Tokyo (JP)

(72) Inventor: Shinsuke FUJIKAWA, CHINO-SHI (JP)

(73) Assignee: SEIKO EPSON CORPORATION, Tokyo (JP)

(21) Appl. No.: 19/084,798

(22) Filed: Mar. 20, 2025

(30) Foreign Application Priority Data
Mar. 22, 2024 (JP) 2024-046250

(51) Int. Cl. G03B 21/00; G03B 11/00

(52) U.S. Cl. CPC G03B 21/006; G03B 11/00

(57) ABSTRACT

A display device including a liquid crystal panel and an optical detection unit is provided. The liquid crystal panel includes a first substrate and a second substrate provided to face each other and a liquid crystal layer provided between the first substrate and the second substrate. The liquid crystal panel has a first surface directed in a normal direction of the first substrate and on which light in a first wavelength region is incident, and a second surface intersecting the first surface. The optical detection unit is configured to detect light in a second wavelength region, which is longer than the first wavelength region, emitted from the second surface when the light in the first wavelength region is incident on the liquid crystal layer.

### BACKGROUND

The present application is based on, and claims priority from JP Application Serial Number 2024-046250, filed Mar. 22, 2024, the disclosure of which is hereby incorporated by reference herein in its entirety.

### 1. Technical Field

The present disclosure relates to a display device and a control method for a display device.

### 2. Related Art

In a projection type display device, a transmissive liquid crystal panel or a reflective liquid crystal panel is irradiated with light emitted from a light source, and transmitted light or reflected light modulated by the liquid crystal panel is projected onto a screen. In such a display device, since the liquid crystal panel is irradiated with high-intensity light from the light source, the liquid crystal panel may deteriorate.

For example, JP-A-2008-40016 describes a liquid crystal display device that detects the chromaticity or illuminance of a light beam emitted from a liquid crystal panel using an optical sensor, and determines the image quality of an optical image based on a detection result, thereby controlling a cooling means.

In such a display device, it is desirable to accurately detect a degree of deterioration of the liquid crystal panel.

### SUMMARY

A display device according to an aspect of the present disclosure includes: a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface; and an optical detection unit configured to detect light in a second wavelength region, which is longer than the first wavelength region, emitted from the second surface when the light in the first wavelength region is incident on the liquid crystal layer.

A control method for a display device according to an aspect the present disclosure is a control method for a display device including a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface, the control method comprising:
detecting light in a second wavelength region, which is longer than the first wavelength region, emitted from the second surface when the light in the first wavelength region is incident on the liquid crystal layer.

### BRIEF DESCRIPTION OF THE DRAWINGS

FIG. 1 is a diagram schematically illustrating a display device according to the present embodiment.

FIG. 2 is a diagram schematically illustrating an optical modulation device and an optical detection device of the display device according to the present embodiment.

FIG. 3 is a plan view schematically illustrating a liquid crystal panel of the display device according to the present embodiment.

FIG. 4 is a cross-sectional view schematically illustrating the liquid crystal panel of the display device according to the present embodiment.

FIG. 5 is a cross-sectional view schematically illustrating the display device according to the present embodiment.

FIG. 6 is a side view schematically illustrating the display device according to the present embodiment.

FIG. 7 is a graph illustrating change over time in photoluminescence when a liquid crystal layer is irradiated with blue light.

FIG. 8 is a graph illustrating change over time in photoluminescence in an accelerated deterioration test of the liquid crystal panel.

FIG. 9 is a graph illustrating change over time in the photoluminescence in an accelerated deterioration test of the liquid crystal panel.

FIG. 10 is a graph illustrating electro-optical characteristics of the liquid crystal panel.

FIG. 11 is a flowchart showing a process of a deterioration determination unit of the display device according to the present embodiment.

FIG. 12 is a cross-sectional view schematically illustrating a display device according to a first modification example of the present embodiment.

FIG. 13 is a side view schematically illustrating the display device according to the first modification example of the present embodiment.

FIG. 14 is a diagram schematically illustrating an optical modulation device and an optical detection device of a display device according to a second modification example of the present embodiment.

FIG. 15 is a side view schematically illustrating the display device according to a second modification example of the present embodiment.

### DESCRIPTION OF EMBODIMENTS

A preferred embodiment of the present disclosure is described in detail below with reference to the drawings. Note that the embodiments described below do not unduly limit the content of the present disclosure described in the claims. In addition, not all the configurations described below are essential constituent elements of the present disclosure.

### 1. Display Device

### 1.1. Overall Configuration

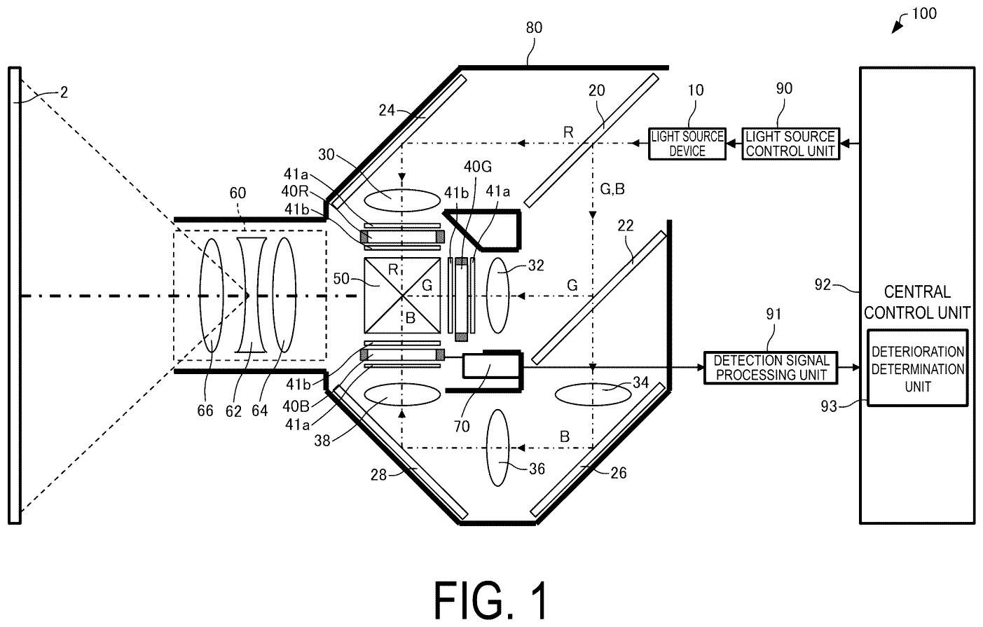

First, a display device 100 according to the present embodiment will be described with reference to the drawings. FIG. 1 is a diagram schematically illustrating the display device 100 according to the present embodiment.

As illustrated in FIG. 1, the display device 100 includes, for example, a light source device 10, dichroic mirrors 20 and 22, reflective mirrors 24, 26, and 28, relay lenses 30, 32, 34, 36, and 38, optical modulation devices 40R, 40G, and 40B, a cross dichroic prism 50 as a light combination device, a projection optical system 60, an optical detection device 70, a housing 80, a light source control unit 90, a detection signal processing unit 91, and a central control unit 92. The display device 100 is, for example, a 3LCD (Liquid Crystal Display) type projector.

The light source device 10 includes, for example, a light source and an optical system, although not shown. The light source is, for example, a lamp unit configured of an array light source having a semiconductor laser or a white light source such as an ultra-high pressure mercury lamp or a halogen lamp. The light from the light source is incident on the optical system. The optical system is, for example, an integrator lens that increases the uniformity of light from the light source.

The dichroic mirror 20 transmits red light (R) from light emitted from the light source device 10, and reflects green light (G) and blue light (B). The dichroic mirror 22 reflects the green light (G) reflected by the dichroic mirror 20 and transmits the blue light (B).

The red light (R) transmitted through the dichroic mirror 20 is reflected by the reflective mirror 24 and then incident on the optical modulation device 40R via a relay lens 30. The green light (G) reflected by the dichroic mirror 22 is incident on the optical modulation device 40G via the relay lens 32. The blue light (B) transmitted through the dichroic mirror 22 passes through the relay lens 34, the reflective mirror 26, the relay lens 36, the reflective mirror 28, and the relay lens 38 and is incident on the optical modulation device 40B.

The optical modulation devices 40R, 40G, and 40B are disposed to face light incidence surfaces of the cross dichroic prism 50 for respective colored lights. The optical modulation devices 40R, 40G, and 40B modulate the incident colored lights based on video information (video signal).

The colored lights modulated by the optical modulation devices 40R, 40G, and 40B are emitted toward the cross dichroic prism 50. In the illustrated example, each of the optical modulation devices 40R, 40G, and 40B is provided between the first polarizing element 41a and the second polarizing element 41b. Details of the optical modulation devices 40R, 40G, and 40B will be described later.

In the cross dichroic prism 50, four right-angle prisms are bonded together, and a dielectric multilayer film that reflects red light and a dielectric multilayer film that reflects blue light are disposed in a cross shape on an inner surface of the prism. Three color lights are combined by the dielectric multilayer films and light representing a color image is combined. The light combined by the cross dichroic prism 50 is emitted toward the projection optical system 60.

The projection optical system 60 projects the incident combined light onto the screen 2. The image is enlarged and displayed on the screen 2. The projection optical system 60 includes a plurality of lenses, that is, a lens 62 that is a biconvex lens, a lens 64 that is a biconcave lens, and a lens 66 that is a biconvex lens.

The optical detection device 70 is provided on the side of the optical modulation device 40B. When the blue light is incident on the liquid crystal panel 41 of the optical modulation device 40B, the optical detection device 70 detects the light emitted from the side of the optical modulation device 40B. Details of the optical detection device 70 will be described later.

The housing 80 accommodates, for example, the light source device 10, the dichroic mirrors 20 and 22, the reflective mirrors 24, 26 and 28, the relay lenses 30, 32, 34, 36 and 38, the optical modulation devices 40R, 40G and 40B, the cross dichroic prism 50, and the projection optical system 60. A material of the housing 80 is, for example, metal or resin.

The light source control unit 90 is electrically coupled to the light source of the light source device 10. The light source control unit 90 controls the light source of the light source device 10. The light source control unit 90 generates a drive signal based on a signal from the central control unit 92 and transmits the generated drive signal to the light source of the light source device 10.

The detection signal processing unit 91 is electrically coupled to the optical detection device 70. The detection signal processing unit 91 acquires a detection signal from the optical detection device 70 and transmits the acquired detection signal to the central control unit 92.

The central control unit 92 controls the light source of the light source device 10 via the light source control unit 90. Further, the central control unit 92 acquires the detection signal from the optical detection device 70 via the detection signal processing unit 91. The light source control unit 90, the detection signal processing unit 91, and the central control unit 92 include, for example, an integrated circuit (IC).

The central control unit 92 includes a deterioration determination unit 93. The deterioration determination unit 93 determines a degree of deterioration of the liquid crystal panel 42 of the optical modulation device 40B based on the acquired detection signal. Specific processing of the deterioration determination unit 93 will be described later.

The display device 100 can be applied to various electronic devices such as a liquid crystal panel for a photocurable 3D printer, an electrical view finder (EVF), a mobile mini projector, a head-up display, a smartphone, a mobile phone, a mobile computer, a digital camera, a digital video camera, a display, an in-vehicle device, an audio device, an exposure device, or a lighting device, in addition to the projector.

### 1.2. Optical Modulation Device

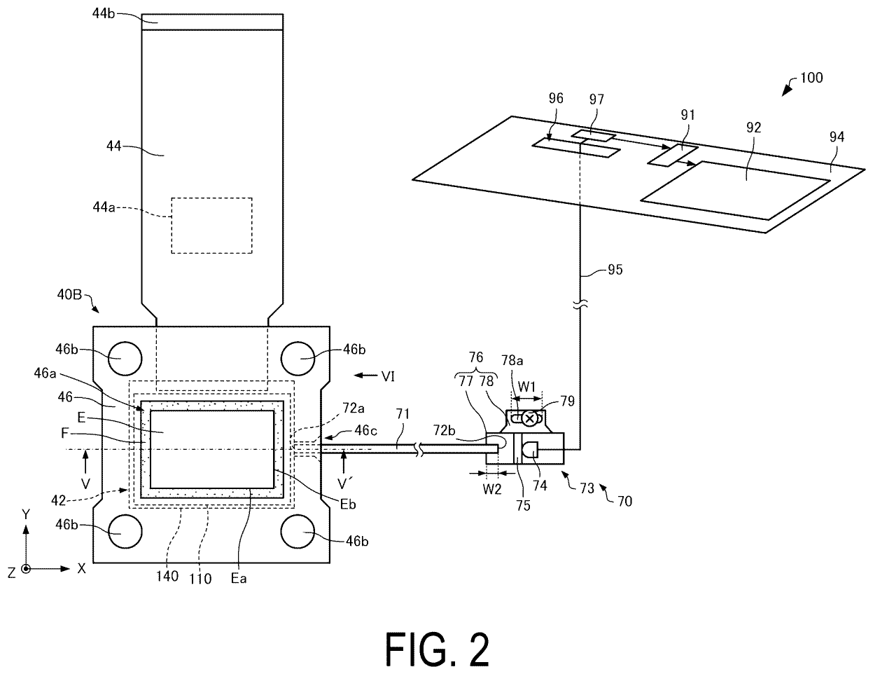

FIG. 2 is a diagram schematically illustrating the optical modulation device 40B. In FIG. 2, an X-axis, Y-axis, and Z-axis are shown as three mutually orthogonal axes.

As illustrated in FIG. 2, the optical modulation device 40B includes a liquid crystal panel 42, a chip on film (COF) 44, and a holder 46. The liquid crystal panel 42 modulates the incident light based on video information. The liquid crystal panel 42 is an active drive type liquid crystal panel having a thin film transistor (TFT) as a transistor for each pixel.

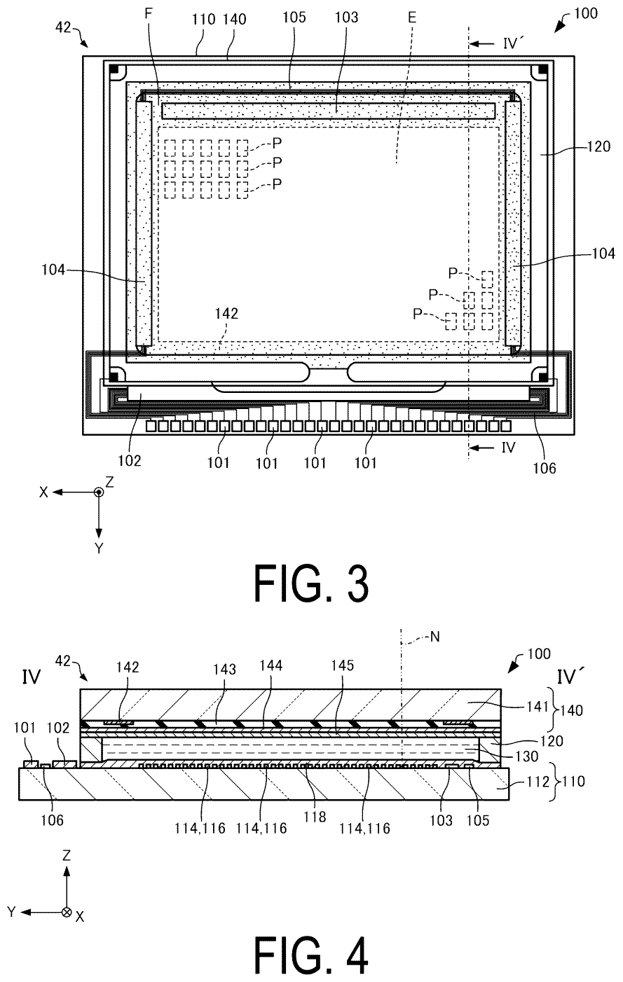

FIG. 3 is a plan view schematically illustrating the liquid crystal panel 42. FIG. 4 is a cross-sectional view taken along line IV-IV′ in FIG. 3 schematically illustrating the liquid crystal panel 42.

As illustrated in FIGS. 3 and 4, the liquid crystal panel 42 includes, for example, an element substrate 110, a sealant material 120, a liquid crystal layer 130, and a counter substrate 140.

As illustrated in FIG. 3, the element substrate 110 is larger than the counter substrate 140 when viewed from the normal direction of the element substrate 110 of the optical modulation device 40B (hereinafter, simply referred to as “viewed from a normal direction”). A planar shape of the element substrate 110 is, for example, a rectangle. In the example illustrated in FIG. 4, a normal direction is a direction in which a normal N of a surface of the first support substrate 112 of the element substrate 110 on the liquid crystal layer 130 side extends, and is a Z-axis direction. Further, in the example shown in the figure, the normal direction is a direction in which the element substrate 110 and the liquid crystal layer 130 are stacked.

The sealant material 120 bonds the element substrate 110 and the counter substrate 140. The sealant material 120 is provided along an outer edge of the counter substrate 140. The sealant material 120 surrounds the liquid crystal layer 130 when viewed from the normal direction. The sealant material 120 is, for example, an adhesive such as a thermosetting, photosetting, or electron beam curing epoxy resin. A display region E including a plurality of pixels P disposed in a matrix is provided inside the sealant material 120. The display region E is surrounded by a peripheral area F. In the peripheral area F, a framing portion 142 surrounding the display region E is provided between the sealant material 120 and the display region E. A material of the framing portion 142 is, for example, a light-shielding metal or metal oxide.

The element substrate 110 includes, for example, an external coupling terminal 101, a data line drive circuit 102, an inspection circuit 103, a scanning line drive circuit 104, a first wiring 105, and a second wiring 106.

A plurality of external coupling terminals 101 are provided. In the illustrated example, the plurality of external coupling terminals 101 are disposed in an X-axis direction. The data line drive circuit 102 is provided between a first side along the plurality of external coupling terminals 101 and the sealant material 120. The inspection circuit 103 is provided between the sealant material 120 along a second side opposite to the first side and the display region E. The scanning line drive circuit 104 is provided between the sealant material 120 along third and fourth sides that are perpendicular to the first side and face each other and the display region E. Although not illustrated, the inspection circuit 103 may be provided between the sealant material 120 along the data line drive circuit 102 and the display region E.

The first wiring 105 is provided between the sealant material 120 along the second side and the inspection circuit 103. The first wiring 105 is coupled to two scanning line drive circuits 104. There is a plurality of first wirings 105. The second wiring 106 is coupled to the data line drive circuit 102 and the scanning line drive circuit 104. The second wiring 106 is electrically coupled to the plurality of external coupling terminals 101. There is a plurality of second wirings 106.

As illustrated in FIG. 4, the element substrate 110 includes, for example, a first support substrate 112, a pixel electrode 114, a TFT 116, and a first alignment layer 118.

The first support substrate 112 supports the pixel electrode 114, the TFT 116, and the first alignment layer 118. The first support substrate 112 is, for example, a glass substrate or a quartz substrate. The first support substrate 112 transmits the light emitted from the light source.

The pixel electrode 114 and the TFT 116 are provided on the liquid crystal layer 130 side of the first support substrate 112. The pixel electrode 114 and the TFT 116 are provided for each pixel P. A plurality of pixel electrodes 114 and TFTs 116 are provided to correspond to the plurality of pixels P. The pixel electrode 114 and the TFT 116 constitute the pixel P. The pixel electrode 114 is a transparent electrode such as indium tin oxide (ITO) or indium zinc oxide (IZO). The TFT 116 is a switching element.

The first alignment layer 118 is provided on the liquid crystal layer 130 side of the first support substrate 112. The first alignment layer 118 covers the pixel electrodes 114, the TFTs 116, and the first wiring 105. The first alignment layer 118 is, for example, an inorganic alignment layer such as a silicon oxide layer, or an organic alignment layer such as a polyimide layer.

The liquid crystal layer 130 is provided between the element substrate 110 and the counter substrate 140. The liquid crystal layer 130 is formed by sealing a gap between the element substrate 110 and the counter substrate 140 with liquid crystal having positive or negative dielectric anisotropy.

The counter substrate 140 is provided on the side of the liquid crystal layer 130 opposite to the element substrate 110. The counter substrate 140 faces the element substrate 110. The light emitted from the light source is incident on the counter substrate 140.

The counter substrate 140 includes, for example, a second support substrate 141, a framing portion 142, an insulating layer 143, a counter electrode 144, and a second alignment layer 145.

The second support substrate 141 faces the first support substrate 112. The second support substrate 141 supports the framing portion 142 and the insulating layer 143. The second support substrate 141 is, for example, a glass substrate or a quartz substrate. The second support substrate 141 transmits the light emitted from the light source. An area of the second support substrate 141 is, for example, smaller than an area of the first support substrate 112 when viewed from the normal direction.

The framing portion 142 is provided on the liquid crystal layer 130 side of the second support substrate 141. The framing portion 142 overlaps the inspection circuit 103 and the scanning line drive circuit 104, when viewed from the normal direction, as illustrated in FIG. 3. The framing portion 142 blocks light incident from the counter substrate 140 side so that the light is not incident on peripheral circuits such as the inspection circuit 103 or the scanning line drive circuit 104. This can curb malfunctions of the peripheral circuits. Further, the framing portion 142 reduces the incidence of unnecessary stray light on the display region E. This can curb a decrease in contrast of the liquid crystal panel 42.

As illustrated in FIG. 4, the insulating layer 143 is provided on the liquid crystal layer 130 side of the second support substrate 141. The insulating layer 143 covers the framing portion 142. The insulating layer 143 is provided between the liquid crystal layer 130 and the second support substrate 141. A surface of the insulating layer 143 on the liquid crystal layer 130 side is, for example, a flat surface. The insulating layer 143 transmits the light emitted from the light source. The insulating layer 143 is, for example, a silicon oxide layer.

The counter electrode 144 is provided on the liquid crystal layer 130 side of the insulating layer 143. The counter electrode 144 is provided between the liquid crystal layer 130 and the insulating layer 143. The counter electrode 144 is, for example, a transparent electrode such as ITO or IZO.

The second alignment layer 145 is provided on the liquid crystal layer 130 side of the counter electrode 144. The liquid crystal layer 130 is provided between the first alignment layer 118 and the second alignment layer 145. The second alignment layer 145 is, for example, an inorganic alignment layer such as a silicon oxide layer, or an organic alignment layer such as a polyimide layer.

For the liquid crystal panel 42, optical design for a normally white mode or a normally black mode is employed. In the normally white mode, a transmittance of the pixel P when no voltage is applied is higher than a transmittance when the voltage is applied. In the normally black mode, the transmittance of the pixel P when no voltage is applied is lower than the transmittance when the voltage is applied. In the example illustrated in FIG. 1, the liquid crystal panel 42 is a transmissive type, but the liquid crystal panel 42 may be a reflective type.

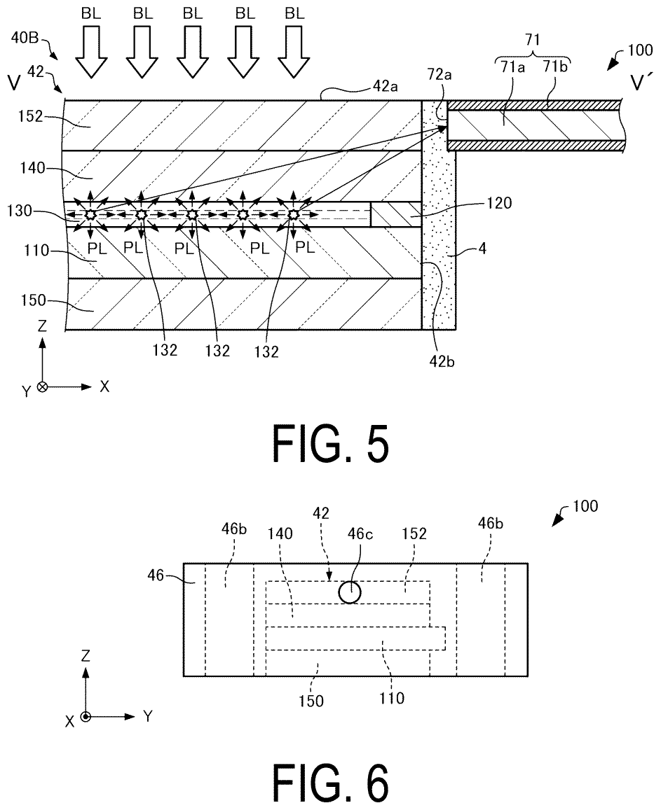

FIG. 5 is a cross-sectional view taken along line V-V′ in FIG. 2, which schematically illustrates the display device 100. However, for convenience of drawing, the light guide unit 71 side of the optical detection device 70 from the sealant material 120 on the V side is illustrated. Further, members other than the liquid crystal panel 42, the light guide unit 71 of the optical detection device 70, and an index matching material 4 are not illustrated in FIG. 5. Further, in FIG. 5, the liquid crystal panel 42 is illustrated in a simplified form.

As illustrated in FIG. 5, the liquid crystal panel 42 further includes, for example, a first dustproof substrate 150 and a second dustproof substrate 152. The first dustproof substrate 150 is provided on the side of the element substrate 110 opposite to the liquid crystal layer 130. The element substrate 110 is provided between the first dustproof substrate 150 and the liquid crystal layer 130. The second dustproof substrate 152 is provided on the side of the counter substrate 140 opposite to the liquid crystal layer 130. The counter substrate 140 is provided between the second dustproof substrate 152 and the liquid crystal layer 130. The dustproof substrates 150 and 152 transmit the light from the light source. A material of the dustproof substrates 150 and 152 is, for example, glass. The dustproof substrates 150 and 152 are used to make dust invisible because any dust adhering to surfaces thereof becomes out of focus.

The liquid crystal panel 42 includes a first surface 42a on which the blue light BL is incident, and a second surface 42b intersecting with the first surface 42a. In the illustrated example, the first surface 42a is formed by the second dustproof substrate 152. The first surface 42a is a surface facing the normal direction. In the illustrated example, the first surface 42a faces a +Z axis direction. The second surface 42b is coupled to the first surface 42a. In the illustrated example, the second surface 42b is perpendicular to the first surface 42a. The second surface 42b is a surface that faces a direction perpendicular to the normal direction. In the illustrated example, the second surface 42b faces an +X axis direction. The second surface 42b is a side surface of the liquid crystal panel 42.

As illustrated in FIG. 2, the COF 44 is coupled to the liquid crystal panel 42. The COF 44 includes a drive IC 44a that drives the liquid crystal panel 42. The COF 44 further includes a connector 44b. The connector 44b may include a reinforcing plate. Although not illustrated, the connector 44b may be coupled to the circuit board 94.

The holder 46 supports the liquid crystal panel 42. In other words, the holder 46 accommodates the liquid crystal panel 42. An end portion of the COF 44 opposite to the connector 44b is typically inserted to fit into a concave portion provided in the holder 46. A material of the holder 46 is, for example, metal or resin.

An opening 46a is formed in the holder 46. The opening 46a overlaps the display region E of the liquid crystal panel 42 when viewed from the normal direction. The opening 46a is formed at the second dustproof substrate 152 side. Although not shown, for example, an opening overlapping the display region E when viewed from the normal direction is formed at the second dustproof substrate 152 side.

Bolt holes 46b are formed in the holder 46. In the illustrated example, four bolt holes 46b are formed. Bolts (not illustrated) are inserted into the bolt holes 46b. The holder 46 is supported within the housing 80 by the bolts, allowing precise alignment with the cross dichroic prism 50.

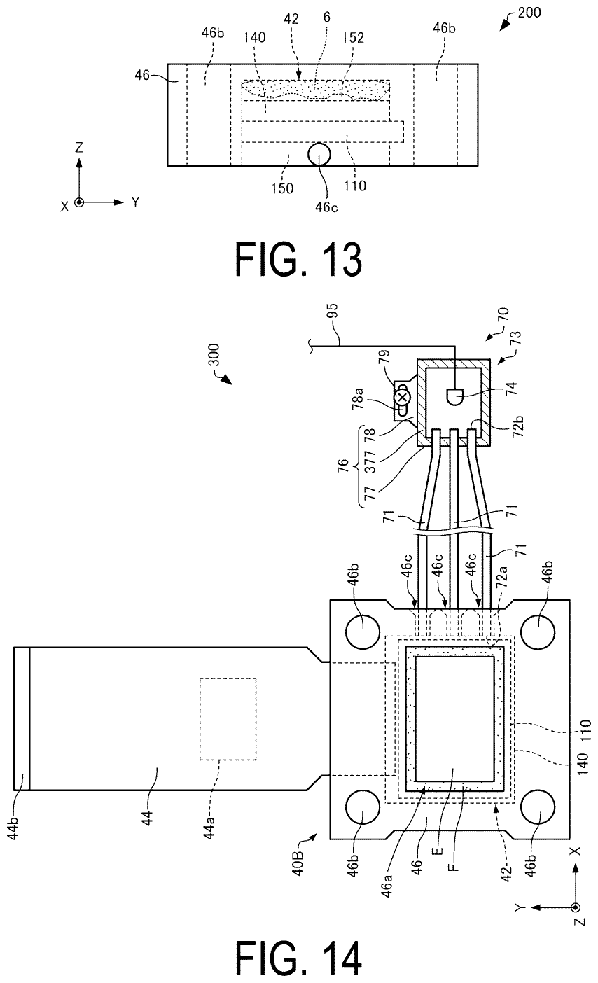

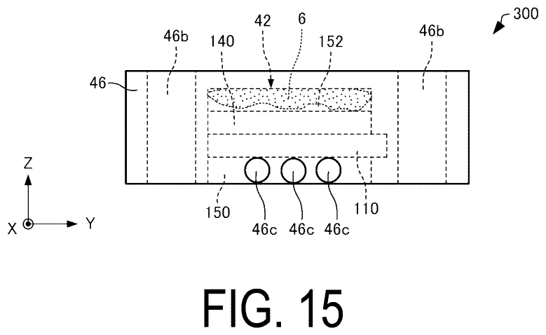

FIG. 6 is a side view schematically illustrating the display device 100, as viewed from a direction of an arrow VI in FIG. 2. For convenience, components other than the liquid crystal panel 42 and the holder 46 are not illustrated in FIG. 6. Further, the liquid crystal panel 42 is illustrated as a dashed line for transparency and in a simplified form, in FIG. 6. That is, the liquid crystal panel 42 is basically hidden by the holder 46 and cannot be seen when viewed from the direction of the arrow VI in FIG. 2. This also applies to FIGS. 13 and 15, which will be described later.

As illustrated in FIGS. 2 and 6, a through hole 46c is formed in the holder 46. The through hole 46c is provided on the side of the liquid crystal panel 42 in the holder 46. The display region E of the liquid crystal panel 42 has a shape having a long-side direction and a short-side direction when viewed from the normal direction, as illustrated in FIG. 2. A shape of the display region E is, for example, a rectangle having a long side Ea and a short side Eb. The through hole 46c is provided on the short side Eb side of the display region E. When viewed from the normal direction, the through hole 46c overlaps the second surface 42b of the liquid crystal panel 42 constituting the short side Eb. The through hole 46c is, for example, chamfered. This makes it easy to insert the light guide unit 71 into the through hole 46c. In the example illustrated in FIG. 6, when viewed from the X-axis direction, the through hole 46c overlaps the second dustproof substrate 152. When viewed from the X-axis direction, the through hole 46c does not overlap the liquid crystal layer 130. Although not shown, the through hole 46c may overlap the counter substrate 140 as long as the through hole 46c does not overlap the liquid crystal layer 130.

The liquid crystal panel 42 of the optical modulation device 40B has been described above, but a configuration of the liquid crystal panel 42 of the optical modulation devices 40R and 40G is basically the same as the configuration of the liquid crystal panel 42 of the optical modulation device 40B except that the through hole 46c is formed in the holder 46.

### 1.3. Optical Detection Device

The optical detection device 70 includes, for example, a light guide unit 71 and an optical detector 73, as illustrated in FIG. 2.

The light guide unit 71 is, for example, an optical fiber. A shape of the light guide unit 71 is, for example, a linear shape. The light guide unit 71 contains, for example, a hard material such as glass. One end of the light guide unit 71 is inserted into the through hole 46c formed in the holder 46. A light incidence surface 72a of the light guide unit 71 constitutes the one end of the light guide unit 71. The light incidence surface 72a of the light guide unit 71 is provided on the short side Eb side of the liquid crystal panel 42. The light incidence surface 72a is provided along a short-side direction of the liquid crystal panel 42. The other end of the light guide unit 71 is inserted into the support unit 76 of the optical detector 73. A light emission surface 72b of the light guide unit 71 constitutes the other end of the light guide unit 71.

As illustrated in FIG. 5, the light guide unit 71 includes a core 71a and a clad 71b surrounding the core 71a. When the blue light BL is incident on the liquid crystal layer 130, the light guide unit 71 guides light PL emitted from the deterioration substance 132 of the liquid crystal layer 130 to the optical detector 73. Specifically, the light PL is incident on the light guide unit 71 from the light incidence surface 72a of the light guide unit 71, passes through while being reflected at a boundary between the core 71a and the clad 71b of the light guide unit 71, is emitted from the light emission surface 72b of the light guide unit 71, and is incident on an optical detection unit 74 of the optical detector 73.

As illustrated in FIG. 5, the deterioration substance 132 is generated in the liquid crystal layer 130 as a use time with incidence of light passes. The deterioration substance 132 is a material that is generated by irradiating the liquid crystal layer 130 with the blue light BL. When the blue light BL is incident on the liquid crystal layer 130, the deterioration substance 132 emits the light PL. The light PL includes light with a longer wavelength region than the blue light BL. A wavelength of the light PL includes, for example, a wavelength region of 550 nm or more and 650 nm. A wavelength of the blue light BL is, for example, 430 nm or more and 490 nm or less. The light PL is, for example, red light. The light PL is the photoluminescence (phosphorescence) in the deterioration substance 132. The light PL is emitted approximately isotropically from the deterioration substance 132.

The light incidence surface 72a of the light guide unit 71 faces the second surface 42b of the liquid crystal panel 42. In the illustrated example, the second surface 42b includes a surface of the element substrate 110, a surface of the sealant material 120, a surface of the counter substrate 140, and surfaces of the dustproof substrates 150 and 152. Further, the second surface 42b may include surfaces of the alignment layers 118 and 145 and a surface of the counter electrode 144. The light incidence surface 72a is, for example, parallel to the second surface 42b. In the illustrated example, the light guide unit 71 is provided to be parallel to the X-axis.

The index matching material 4 is disposed between the light incidence surface 72a of the light guide unit 71 and the second surface 42b of the liquid crystal panel 42. The display device 100 has the index matching material 4. A difference in refractive index between the index matching material 4 and the core 71a is smaller than a difference in refractive index between air and the core 71a. The index matching material 4 is, for example, made of a silicon-based material. The index matching material 4 improves the incidence efficiency of the light PL on the light incidence surface 72a of the light guide unit 71.

The light incidence surface 72a of the light guide unit 71 does not overlap the sealant material 120 when viewed from the Y-axis direction. The light incidence surface 72a is not provided on the side of the sealant material 120. In the illustrated example, the light incidence surface 72a overlaps the second dustproof substrate 152 when viewed from the Y-axis direction. Although not illustrated, the light incidence surface 72a may overlap the counter substrate 140 when viewed from the Y-axis direction.

As illustrated in FIG. 2, the optical detector 73 includes, for example, the optical detection unit 74, a wavelength filter 75, and a support unit 76.

When light BL is incident on the liquid crystal layer 130, the optical detection unit 74 detects the light PL emitted from the second surface 42b of the liquid crystal panel 42. The optical detection unit 74 is, for example, a photodiode, a camera, or a spectrometer.

The wavelength filter 75 is provided between the optical detection unit 74 and the light emission surface 72b of the light guide unit 71. The wavelength filter 75 is, for example, a wavelength cut filter that transmits the light PL and reduces the light BL. The wavelength filter 75 may completely cut the light BL.

The support unit 76 includes, for example, a light shield 77 and a fixing portion 78.

The light shield 77 is a housing that accommodates the optical detection unit 74 and the wavelength filter 75. The light shield 77 can reduce stray light that is incident on the optical detection unit 74. The light emission surface 72b of the light guide unit 71 is inserted into the light shield 77. A material of the light shield 77 is, for example, metal or resin.

The fixing portion 78 is coupled to the light shield 77. An elongated hole 78a is formed in the fixing portion 78. In the illustrated example, the elongated hole 78a is formed along the X-axis. The fixing portion 78 is fixed to the housing 80 by, for example, a screw 79 inserted into the elongated hole 78a. In the X-axis direction, a length W1 of the elongated hole 78a is larger than a length W2 of the portion of the light guide unit 71 inserted into the light shield 77. Therefore, after the optical detector 73 is temporarily attached to the housing 80, the optical detector 73 is moved toward the light guide unit 71 so that the light guide unit 71 can be inserted into the optical detector 73. This makes it possible to avoid damage to the light guide unit 71 while not applying unnecessary bending stress to the light guide unit 71. Therefore, it is possible to easily attach the support unit 76 to the housing 80 while inserting the other end of the light guide unit 71 into the light shield 77.

A coupling cable 95 is coupled to the optical detection unit 74 of the optical detection device 70. The coupling cable 95 passes through an opening 96 formed in the circuit board 94 and is coupled to the connector 97. In the illustrated example, the circuit board 94 includes a detection signal processing unit 91 and the central control unit 92. As a disposition of the circuit board 94, for example, a configuration in which this overlaps and covers the cross dichroic prism 50 in FIG. 1 is used. Therefore, it is possible to shorten the coupling cable 95 and facilitate installation by the coupling cable 95 passing through the opening 96.

### 1.4. Change Over Time of Liquid Crystal Panel and Photoluminescence

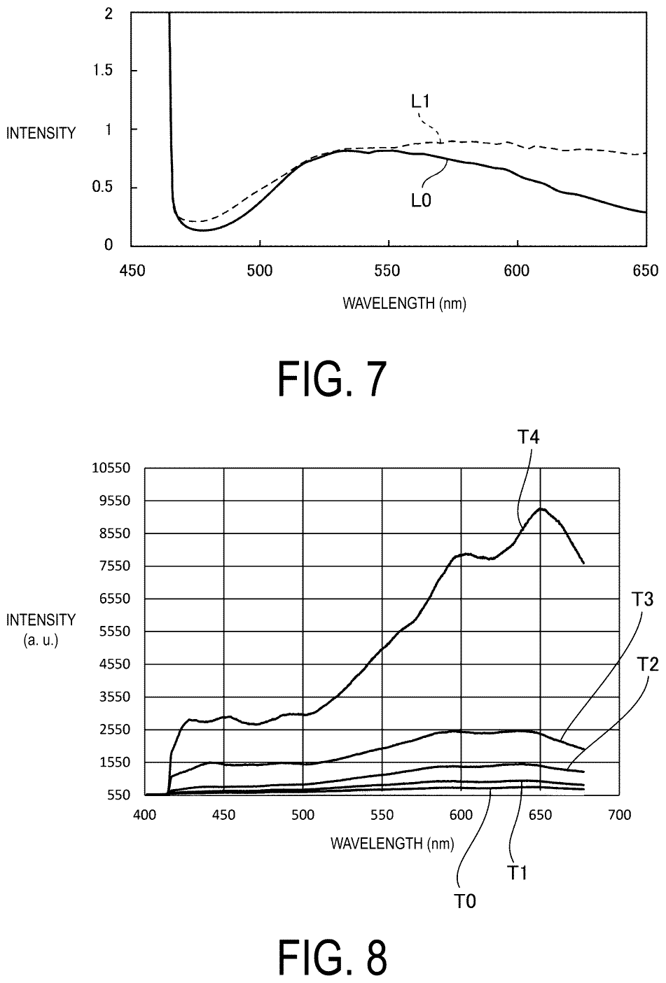

FIG. 7 is a graph showing change over time of the photoluminescence when the liquid crystal layer is irradiated with blue light. In FIG. 7, a horizontal axis is a measured wavelength, and a vertical axis is a radiated light intensity observed from the liquid crystal layer irradiated with the blue light. A solid line LO indicates an initial spectrum when the liquid crystal layer begins to be irradiated with the blue light, and a dashed line L1 indicates a spectrum at a stage when the liquid crystal layer has been irradiated with the blue light for a certain period of time. It is presumed that a spectrum other than the spectrum corresponding to the incident light is based on the photoluminescence of the deterioration substance generated in the liquid crystal layer. In FIG. 7 and FIGS. 8 to 10, which will be described later, cases where both blue light and the photoluminescence are detected are illustrated.

As illustrated in FIG. 7, when the liquid crystal layer is continuously irradiated with blue light having an intensity peak near 450 nm for a certain period of time, an intensity of a spectrum of emission light emitted from the liquid crystal layer increases. In particular, an intensity of a band with wavelengths from 550 nm to 650 nm increases, and the emission light is observed as light with an increased proportion of a red component. When electrons transition between liquid crystal molecules, predetermined light is emitted, but when a deterioration substance is present due to a photochemical reaction or the like, it is estimated that emission light including phosphorescence with a wavelength of 550 nm to 650 nm is emitted.

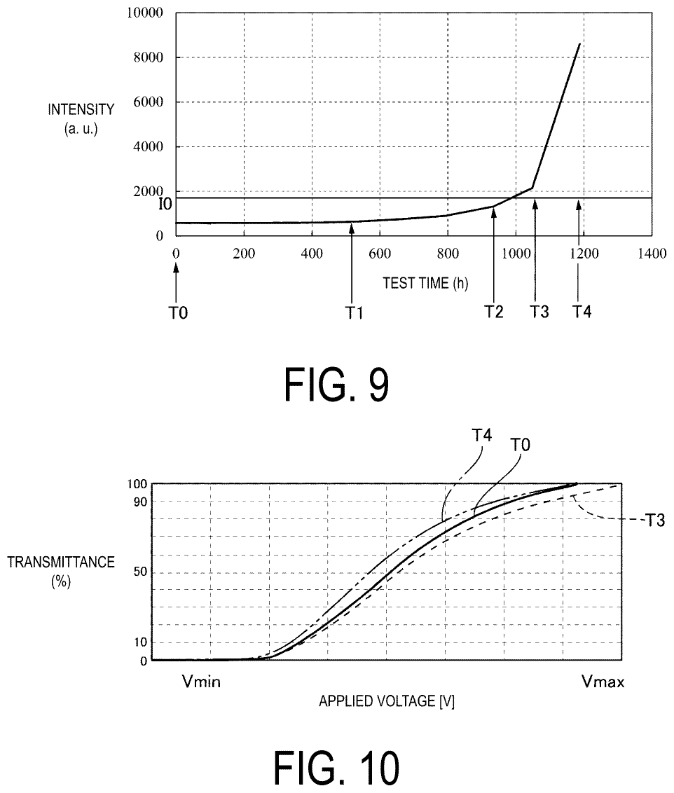

FIGS. 8 and 9 are graphs showing change over time in the photoluminescence in an accelerated degradation test of the liquid crystal panel. FIG. 8 shows spectra for test times T0, T1, T2, T3, and T4. In FIG. 8, a horizontal axis is a measured wavelength, and a vertical axis is the radiated light intensity observed from the liquid crystal layer. FIG. 9 shows a change over time in the radiated light intensity in a band from 500 nm to 650 nm. In FIG. 9, a horizontal axis is a test time, and a vertical axis is the radiated light intensity in the wavelength region observed from the liquid crystal layer. In FIG. 9, points corresponding to the test times T0, T1, T2, T3, and T4 illustrated in FIG. 8 are illustrated. In the accelerated deterioration test illustrated in FIGS. 8 and 9, the liquid crystal panel was irradiated with blue light with a high luminous flux density, and the radiated light of the liquid crystal panel was observed from the light incidence side.

FIG. 10 is a graph illustrating electro-optical characteristics (V-T characteristics) of the liquid crystal panel. In FIG. 10, a vertical axis indicates transmittance, and a horizontal axis indicates a voltage applied to the liquid crystal layer of the liquid crystal panel. In FIG. 10, V-T curves of the liquid crystal panel corresponding to the test times T0, T3, and T4 are illustrated.

A main cause of the change over time in the radiated light intensity observed in the liquid crystal panel is change over time in the photoluminescence intensity from the liquid crystal panel. The test time T0 indicates an initial state, and T1<T1<T2<T3<T4. The irradiation with the blue light increases the intensity of the spectrum of the radiated light due to the photoluminescence. At test times T1 and T2, the photoluminescence intensity increases in the band from 500 nm to 650 nm. At test times T3 and T4, the photoluminescence intensity further increases over the entire measured wavelength region, and the photoluminescence intensity in the band from 500 nm to 650 nm greatly increases. For example, test times T3 and T4 are 1.1 and 1.2 times longer than test time T2, respectively. The photoluminescence intensities at test times T3 and T4 are, for example, 1.5 times and 3 times the photoluminescence intensity at test time T2, respectively. The V-T curve of the liquid crystal panel at test time T3 changes to a darker state, the V-T curve of the liquid crystal panel at test time T4 changes to a brighter state, and the display quality of the liquid crystal panel decreases. It can be seen that the deterioration of the liquid crystal panel progresses rapidly from test time T3. Therefore, the degree of the deterioration of the liquid crystal panel can be ascertained from change in the photoluminescence intensity.

It is presumed that an increase in the photoluminescence intensity from the liquid crystal panel is due to an increase in concentration of deterioration substances in the liquid crystal layer. After test time T4, the deterioration further progresses, and the liquid crystal panel becomes unable to recover the display quality even through correction or the like, and the lifespan of the liquid crystal panel comes to an end. For example, as illustrated in FIG. 9, as a determination as to lifespan, a determination is made that a point in time at which a photoluminescence intensity 10 observed between test time T2 and test time T3 is detected is the lifespan of the liquid crystal panel. The photoluminescence intensity 10 can be set to a limit value 10 corresponding to the liquid crystal panel.

Therefore, when the intensity of the photoluminescence emitted from the liquid crystal panel is detected, the deterioration of the liquid crystal layer and the deterioration of the liquid crystal panel caused by the deterioration of the liquid crystal layer can be monitored. When the liquid crystal layer is continuously irradiated with the blue light for a certain period of time, the emission light emitted from the liquid crystal panel also contains fluorescent light with a wavelength of 600 nm to 650 nm. Further, when the wavelength of the light with which the liquid crystal layer is irradiated is short, it is easy for the deterioration due to photochemical reactions or the like to progress.

### 1.5. Control Method

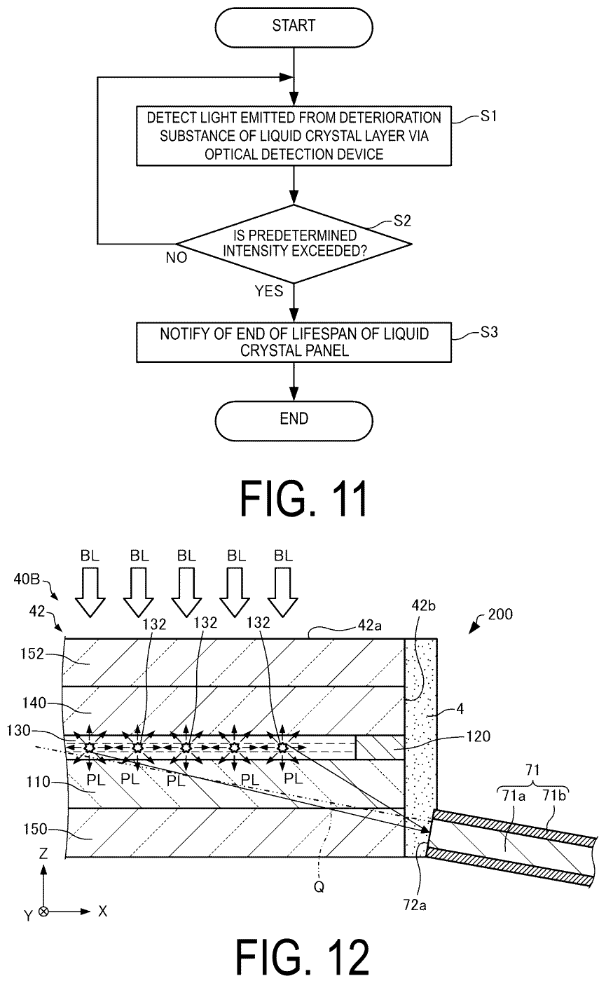

Next, a control method for the display device 100 according to the present embodiment will be described with reference to the drawings. Specifically, a process of the deterioration determination unit 93 of the display device 100 will be described. FIG. 11 is a flowchart showing the process of the deterioration determination unit 93.

The deterioration determination unit 93 starts a process when a signal to start the process is input via an operation unit (not illustrated). For example, a configuration in which the signal to start a process is automatically issued at a stage where a predetermined time has elapsed after light emission from the light source device 10 starts may be adopted. Such a configuration can be realized by executing a program using a microcomputer or the like.

First, as illustrated in FIG. 11, the deterioration determination unit 93 performs a process of detecting the light PL emitted from a deterioration substance 132 in the liquid crystal layer 130 via the optical detection device 70 through irradiation of the liquid crystal layer 130 with the blue light BL (step S1).

Then, the deterioration determination unit 93 performs a process of determining whether or not the intensity of the detected light PL exceeds a predetermined value (step S2). The predetermined value may be set in consideration of the limit value 10 illustrated in FIG. 9.

When a determination is made that the intensity of the light PL does not exceed the predetermined value (“NO” in step S2), the deterioration determination unit 93 returns the process to step S1. Steps S1 and S2 are repeated until a determination is made in step S2 that the intensity of the light PL exceeds the predetermined value.

On the other hand, when a determination is made that the intensity of the light PL exceeds the predetermined value (“YES” in step S2), the deterioration determination unit 93 performs a process of notifying that the liquid crystal panel 42 has reached the end of the lifespan (step S3). Specifically, the deterioration determination unit 93 performs a process of notifying that the liquid crystal panel 42 has reached the end of the lifespan or notifying of a period until it is expected that the liquid crystal panel 42 has reached the end of the lifespan. A means of notification is not particularly limited. For example, the user performs maintenance of the liquid crystal panel 42 after receiving the notification from the deterioration determination unit 93. A determination result may be recorded in a storage means (not illustrated) in the display device 100, or may be transmitted to a server on a network by a communication means (not illustrated) and recorded therein.

The deterioration determination unit 93 ends the process.

When a determination is made that the intensity of the light PL exceeds the predetermined value, for example, the central control unit 92 may transmit a signal to the light source control unit 90 to reduce the output of the light source. Since the deterioration of the liquid crystal panel 42 can be slowed down by doing so, it is possible to ensure sufficient time for the user to perform maintenance.

### 1.6. Effects

The display device 100 includes the element substrate 110 as a first substrate and the counter substrate 140 as a second substrate, which are provided to face each other, and the liquid crystal layer 130 provided between the element substrate 110 and the counter substrate 140, and includes the liquid crystal panel 42 including the first surface 42a on which the light BL in the first wavelength region is incident in the normal direction and the second surface 42b intersecting with the first surface 42a, and the optical detection unit 74 that detects the light PL in the longer wavelength region than the first wavelength region that is emitted from the second surface 42b when the light BL in the first wavelength region is incident on the liquid crystal layer 130.

Therefore, the display device 100 can reduce the light BL in the first wavelength region that is incident on the optical detection unit 74, compared to a case where the light PL in the long wavelength region that is emitted in the normal direction is detected by the optical detection unit. More specifically, in a direction in which the first surface 42a is viewed vertically or obliquely, the intensity of the light BL reflected by the liquid crystal panel 42 is overwhelmingly higher than the intensity of the light PL. However, in a light beam emitted from the second surface 42b, the intensity of the light PL is higher than the intensity of the light BL. This makes it easier to detect changes in the intensity of the light PL. Therefore, the degree of the deterioration of the liquid crystal panel 42 can be detected with high accuracy by observing the light PL emitted from the second surface 42b. Further, the detection sensitivity of the light PL in the optical detection unit 74 can be improved. Thus, the degree of the deterioration of the liquid crystal panel 42 can be detected accurately.

The display device 100 has the light guide unit 71 that guides the light PL in the long wavelength region emitted from the second surface 42b to the optical detection unit 74. Therefore, in the display device 100, the optical detection unit 74 can efficiently detect the light PL in the long wavelength region.

The display device 100 includes the sealant material 120 that couples the element substrate 110 to the counter substrate 140 and surrounds the liquid crystal layer 130, and the light incidence surface 72a of the light guide unit 71 does not overlap the sealant material 120 when viewed from the direction perpendicular to the normal direction. Therefore, in the display device 100, it is possible to curb the light PL in the long wavelength region detected by the optical detection unit 74 being attenuated by passing through the sealant material 120. Further, there is no variation in attenuation rate of the light PL due to a manufacturing variation in a width of the sealant material 120.

In the display device 100, when viewed from the normal direction, the light incidence surface 72a of the light guide unit 71 is provided on the short side Eb side of the display region E of the liquid crystal panel 42. Therefore, in the display device 100, the light PL in the long wavelength region emitted from the liquid crystal layer 130 can be simply observed in an integrated manner and detected along the long side Ea, which is the longer of the long side Ea and short side Eb of the display region E. Therefore, the degree of the deterioration of the liquid crystal panel 42 can be detected with high accuracy. It is not prohibited to provide the light incidence surface 72a of the light guide unit 71 on the long side Ea side of the display region E of the liquid crystal panel 42.

The display device 100 includes the index matching material 4 disposed between the light incidence surface 72a and the second surface 42b of the light guide unit 71. Therefore, in the display device 100, the reflection of the light PL in the long wavelength region on the light incidence surface 72a of the light guide unit 71 can be reduced. Further, even when there are irregularities on the second surface 42b due to the manufacturing process, the reflection due to the irregularities can be reduced by the index matching material 4. Therefore, the light incidence surface 72a of the light guide unit 71 can be disposed in a desired posture.

The display device 100 includes the wavelength filter 75 that is provided between the optical detection unit 74 and the light emission surface 72b of the light guide unit 71 and reduces the light BL in a first wavelength region. Therefore, in the display device 100, the light BL in the first wavelength region that is incident on the optical detection unit 74 can be reduced. Therefore, the light PL caused by the deterioration substance 132 generated in the liquid crystal layer 130 can be observed.

### 2. Modification Example of Display Device

### 2.1. First Modification Example

Next, a display device according to a first modification example of the present embodiment will be described with reference to the drawings. FIG. 12 is a cross-sectional view schematically illustrating a display device 200 according to a first modification example of the present embodiment. FIG. 13 is a side view schematically illustrating the display device 200 according to the first modification example of the present embodiment. For convenience, members other than the liquid crystal panel 42, the light guide unit 71, and the index matching material 4 are not illustrated in FIG. 12. Further, in FIG. 13, members other than the liquid crystal panel 42 and the holder 46 are not illustrated. Further, in FIGS. 12 and 13, the liquid crystal panel 42 is illustrated in a simplified form.

Hereinafter, in the display device 200 according to the first modification example of the present embodiment, members having the same functions as those of the display device 100 described above are denoted by the same reference signs, and detailed description thereof will be omitted.

In the display device 100 described above, the light incidence surface 72a of the light guide unit 71 and the through hole 46c overlap the second dustproof substrate 152 when viewed from the direction perpendicular to the normal direction, as illustrated in FIGS. 5 and 6.

On the other hand, in the display device 200, the light incidence surface 72a of the light guide unit 71 overlaps the first dustproof substrate 150 when viewed from the direction perpendicular to the normal direction, as illustrated in FIG. 12. The through hole 46c overlaps the first dustproof substrate 150 when viewed from the direction perpendicular to the normal direction, as illustrated in FIG. 13.

In the example illustrated in FIG. 12, the light guide unit 71 is tilted with respect to the X-axis direction. The light guide unit 71 is tilted so that the light incidence surface 72a faces the liquid crystal layer 130. The light incidence surface 72a of the light guide unit 71 has a perpendicular line Q that intersects with the liquid crystal layer 130. Therefore, in the display device 200, the light incidence surface 72a of the light guide unit 71 can capture the light PL more efficiently than a case where the light incidence surface does not have a perpendicular line that intersects with the liquid crystal layer.

In the example illustrated in FIG. 13, the second dustproof substrate 152 and an inner wall of the holder 46 are bonded with a thermally conductive adhesive 6. The thermally conductive adhesive 6 may wrap around the side of the second dustproof substrate 152 as illustrated in FIG. 13. Therefore, when the through hole 46c is formed to overlap the first dustproof substrate 150, the light PL can be efficiently incident on the light incidence surface 72a of the light guide unit 71 without being affected by thermally conductive adhesive 6.

### 2.2. Second Modification Example

Next, a display device according to a second modification example of the present embodiment will be described with reference to the drawings. FIG. 14 is a diagram schematically illustrating an optical modulation device 40B and an optical detection device 70 of a display device 300 according to a second modification example of the present embodiment. FIG. 15 is a side view schematically illustrating the display device 300 according to the second modification of the present embodiment. For convenience, members other than the liquid crystal panel 42 and the holder 46 are not illustrated in FIG. 15. FIG. 15 also shows the liquid crystal panel 42 in a simplified form.

Hereinafter, in the display device 300 according to the second modification of the present embodiment, members having the same functions as the constituent members of the display devices 100 and 200 described above are denoted by the same reference signs, and detailed description thereof will be omitted.

In the display device 100 described above, only one light guide unit 71 is provided, as illustrated in FIGS. 2 and 6. Further, only one through hole 46c is formed.

On the other hand, in the display device 300, a plurality of light guide units 71 are provided, as illustrated in FIGS. 14 and 15. Further, a plurality of through holes 46c are formed.

In the example illustrated in FIG. 14, three light guide units 71 are provided, but the number of light guide units is not particularly limited. It is possible to improve the detection sensitivity of the light PL in the optical detection unit 74 by providing a plurality of light guide units 71.

A reflective material 377 is provided on an inner wall of the light shield 77 of the support unit 76. A material of the reflective material 377 is, for example, a metal such as aluminum. The reflective material 377 reflects the light PL emitted from the light emission surface 72b of the light guide unit 71. Therefore, a component not directly directed to the optical detection unit 74 in the light PL emitted from the light emission surface 72b can be reflected by the reflective material 377 and reach the optical detection unit 74.

Three through holes 46c are formed to correspond to the number of light guide units 71. In the display device 300, the through holes 46c overlap the first dustproof substrate 150 when viewed from the direction perpendicular to the normal direction, similar to the display device 200 described above. The second dustproof substrate 152 is adhered to the inner wall of the holder 46 via the thermally conductive adhesive 6.

The above-described embodiment and modification examples are merely examples, and are not limited thereto. For example, each embodiment and each modification example can also be combined together as appropriate.

The present disclosure includes a configuration that is substantially the same as the configuration described in the embodiment, for example, a configuration having the same function, method, and result or a configuration having the same purpose and effects. Also, the present disclosure includes configurations obtained by replacing non-essential portions of the configurations described in the embodiment. Further, the present disclosure includes a configuration having the same effect as the configuration described in the embodiment or a configuration that can achieve the same purpose. Further, the present disclosure includes configurations obtained by adding known techniques to the configurations described in the embodiment.

The following content is derived from the embodiments and modification examples described above.

One aspect of a display device includes a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface; and
an optical detection unit configured to detect light in a second wavelength region, which is longer than the first wavelength region, emitted from the second surface when the light in the first wavelength region is incident on the liquid crystal layer.

According to this display device, the degree of deterioration of the liquid crystal panel can be detected with high accuracy.

The display device according to an aspect may further include a light guide unit configured to guide the light in the long wavelength region emitted from the second surface to the optical detection unit.

According to the display device, the optical detection unit can efficiently detect the light in the long wavelength region.

The display device according to an aspect may further include a sealant material configured to couple the first substrate to the second substrate and surround the liquid crystal layer when viewed from the normal direction, wherein
a light incidence surface of the light guide unit may not overlap the sealant material when viewed from a direction perpendicular to the normal direction.

According to the display device, it is possible to curb attenuation of the light in the long wavelength region detected by the optical detection unit due to passing through the sealant material.

In the display device according to an aspect, the light incidence surface of the light guide unit may have a perpendicular line intersecting with the liquid crystal layer.

According to this display device, the light incidence surface of the light guide unit can efficiently capture light in the long wavelength region.

In the display device according to an aspect, the light incidence surface of the light guide unit may be provided on the short side of the display region of the liquid crystal panel when viewed from the normal direction.

According to this display device, the light in the long wavelength region emitted from the liquid crystal layer can be simply observed in an integrated manner and detected along the long side, which is the longer of the long side and short side of the display region.

The display device according to an aspect may further include an index matching material disposed between the light incidence surface of the light guide unit and the second surface.

According to the display device, the reflection of light in the long wavelength region at the light incidence surface of the light guide unit can be reduced.

The display device according to an aspect may include a wavelength filter provided between the optical detection unit and a light emission surface of the light guide unit, and configured to reduce the light in the first wavelength region.

According to this display device, it is possible to reduce the light in the first wavelength region incident on the optical detection unit.

One aspect of a control method for a display device is a control method for a display device including a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface, the control method including detecting light in a second wavelength region, which is longer than the first wavelength region, emitted from the second surface when the light in the first wavelength region is incident on the liquid crystal layer.

According to this control method for a display device, the degree of deterioration of the liquid crystal panel can be detected with high accuracy.

What is claimed is:

1. A display device comprising:
a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface; and
an optical detection unit configured to detect light in a second wavelength region, which is longer than the first wavelength region, emitted from the second surface when the light in the first wavelength region is incident on the liquid crystal layer.

2. The display device according to claim 1, further comprising:
a light guide unit configured to guide the light in the second wavelength region emitted from the second surface to the optical detection unit.

3. The display device according to claim 2, further comprising:
a sealant material configured to couple the first substrate to the second substrate and surround the liquid crystal layer when viewed from the normal direction, wherein
a light incidence surface of the light guide unit does not overlap the sealant material when viewed from a direction perpendicular to the normal direction.

4. The display device according to claim 3, wherein the light incidence surface of the light guide unit has a perpendicular line intersecting with the liquid crystal layer.

5. The display device according to claim 2, wherein the light incidence surface of the light guide unit is provided on the short side of the display region of the liquid crystal panel when viewed from the normal direction.

6. The display device according to claim 2, further comprising:
an index matching material disposed between the light incidence surface of the light guide unit and the second surface.

7. The display device according to claim 2, further comprising:
a wavelength filter provided between the optical detection unit and a light emission surface of the light guide unit, and configured to reduce the light in the first wavelength region.

8. A control method for a display device including a liquid crystal panel including a first substrate and a second substrate provided to face each other and a liquid crystal layer provided between the first substrate and the second substrate, the liquid crystal panel having a first surface directed in a normal direction of the first substrate and on which light in a first wavelength region is incident, and a second surface intersecting the first surface, the control method comprising:
detecting light in a second wavelength region, which is longer than the first wavelength region, emitted from the second surface when the light in the first wavelength region is incident on the liquid crystal layer.
